(19) United States
(12) Patent Application Publication
(10) Pub. No.: US 2007/0031116 A1
(43) Pub. Date: Feb. 8, 2007

(54) Reproducing apparatus, reproducing method, and content reproducing system

(75) Inventors: Susumu Takatsuka, Tokyo (JP); Hideo Tsukazaki, Tokyo (JP); Takashi Kinouchi, Tokyo (JP); Junichiro Sakata, Tokyo (JP)

Correspondence Address: WOLF GREENFIELD & SACKS, PC, FEDERAL RESERVE PLAZA, 600 ATLANTIC AVENUE, BOSTON, MA, 02210-2206, US

(73) Assignee: Sony Corporation, Tokyo (JP)

(21) Appl. No.: 11/491,377

(22) Filed: Jul. 21, 2006

(30) Foreign Application Priority Data
Aug. 2, 2005 (JP) 2005-224778

(51) Int. Cl. H04N 7/00

(52) U.S. Cl. 386/95

(57) ABSTRACT

A reproducing apparatus is disclosed. The reproducing apparatus has a recording section, a reproducing section, a time information generating section, and a controlling section. The recording section records content data. The reproducing section reproduces the content data. The time information generating section generates time information. The controlling section checks whether the recording section records content data whose expiration date will come soon on the basis of the time information generated by the time information generating section when the reproducing apparatus gets started. When the recording section records content data whose expiration date will come soon, the controlling section notifies a user of the content data whose expiration date will come soon.

### CROSS REFERENCES TO RELATED APPLICATIONS

The present invention contains subject matter related to Japanese Patent Application JP 2005-224778 filed in the Japanese Patent Office on Aug. 2, 2005, the entire contents of which being incorporated herein by reference.

### BACKGROUND OF THE INVENTION

1. Field of the Invention

The present invention relates to a reproducing apparatus that notifies a user of an expiration date that has been assigned to content, a reproducing method thereof, and a content reproducing system thereof.

2. Description of the Related Art

In recent years, many portable reproducing apparatuses using a small hard disk drive as a record medium have been produced as commercial products. The record capacities of small hard disk drives range from around several gigabytes (GB) to around several ten GB, namely a huge amount of content data such as around several hundreds of tracks of content to several thousands of tracks of content. Thus, since the small hard disk drives can record a very large number of tracks of content data, they have been widespread. The housing of these reproducing apparatuses is small and light. Thus, the user can record content of audio data such as songs on a record medium, operate the reproducing apparatus with the record medium outdoor, and enjoy songs which the reproducing apparatus reproduces.

Content reproduced by such a portable reproducing apparatus is transferred from an information device such as a personal computer connected through a so-called communication interface and recorded on a record medium. On the other hand, the personal computer side rips content from a commercial music compact disc (CD), and stores the ripped content in a hard disk drive (HDD), or stores content transferred (downloaded) from a server on the Internet in the HDD. Content stored in the HDD of the personal computer is transferred to the portable reproducing apparatus.

A content download service which a server on the Internet provides has been proposed. In this service, its subscriber is charged for an expiration date of content rather than the number of downloaded tracks thereof. Its subscriber can freely reproduce downloaded content unless it expired. Content which the subscriber can reproduce for a predetermined time period is referred to as subscription content. A reproducible time period of subscription content is limited in such a manner that the content is encrypted and an expiration date is assigned to a key with which the encrypted content is decrypted.

Another related art of which a content provider side controls its subscriber who reproduces downloaded content is described in Japanese Patent Application Unexamined Publication No. 2003-203133. In this related art, the content provider side licenses its subscriber to use content using wireless communication.

### SUMMARY OF THE INVENTION

When a reproduction expiration date is assigned to content, it may be necessary for the reproducing apparatus side to notify its user of the reproduction expiration date. In the related art, if content whose reproduction expiration date has come and which is not able to be reproduced has been recorded in the reproducing apparatus, only when the user selects the content whose expiration date has come and tries to reproduce the content, the apparatus notifies him or her that the expiration date of the content has come and it is not able to be reproduced.

In such a structure, it is difficult for the user to know whether the expiration date of the content has come until he or she selects it. Thus, when the user reproduces the content from the apparatus, it notifies him or her that the content is not able to be reproduced because its expiration date has come. Thus, the technology of the related art is not user-friendly.

If the date on which the user selects content is earlier than the license expiration date of the content by a predetermined time period, he or she may be notified that the expiration date of the content will come soon. In this method, as a merit, when the user selects the content, since he or she is notified of the license expiration date in the state that he or she can reproduce the content, he or she can know the due date of payment of additional fee in advance. However, in this method, whenever the user selects the content, he or she is repeatedly notified that the expiration date of the content will come soon. Thus, the user may feel bothersome.

In view of the foregoing, it would be desirable to provide a reproducing apparatus, a reproducing method, and a content reproducing system which allows a user to be securely notified whether there is content whose expiration date has come without causing him or her to feel uncomfortable.

According to an embodiment of the present invention, there is provided a reproducing apparatus. The reproducing apparatus has a recording section, a reproducing section, a time information generating section, and a controlling section. The recording section records content data. The reproducing section reproduces the content data. The time information generating section generates time information. The controlling section checks whether the recording section records content data whose expiration date will come soon on the basis of the time information generated by the time information generating section when the reproducing apparatus gets started. When the recording section records content data whose expiration date will come soon, the controlling section notifies a user of the content data whose expiration date will come soon.

According to an embodiment of the present invention, there is provided a reproducing method for reproducing content data. Time information is generated. It is checked whether a recording apparatus has content data whose expiration date will come soon on the basis of the time information when the reproducing apparatus gets started. A user is notified of the content data whose expiration date will come soon when the reproducing apparatus has content data whose expiration date will come soon.

According to an embodiment of the present invention, there is provided a system having a reproducing apparatus and an external device. The reproducing apparatus has a recording section, a reproducing section, a time information generating section, and a controlling section. The recording section records content data. The reproducing section reproduces the content data. The time information generating section generates time information. The controlling section checks whether the recording section records content data whose expiration date will come soon on the basis of the time information generated by the time information generating section when the reproducing apparatus gets started. When the recording section records content data whose expiration date will come soon, the controlling section notifies a user of the content data whose expiration date will come soon and transmits license information of content data whose expiration date will come soon to the external device. The external device has a communication section, a managing section, and an updating section. The communication section communicates with the reproducing apparatus. The managing section manages license related information. The updating section updates license information transmitted from the external device on the basis of the license information transmitted from the reproducing apparatus and the license related information managed by the managing section.

As described above, according to embodiments of the present invention, when the apparatus gets started, it checks whether there are content data whose expiration date will come soon on the basis of time information. When there are content data whose expiration date will come soon, the user is notified that the expiration date of the content data will come soon. Thus, the user is securely notified that there are content data whose expiration date will come soon. In addition, whenever the apparatus gets started, the user is not repeatedly notified of that information.

These and other objects, features and advantages of the present invention will become more apparent in light of the following detailed description of a best mode embodiment thereof, as illustrated in the accompanying drawings.

### BRIEF DESCRIPTION OF THE DRAWINGS

The invention will become more fully understood from the following detailed description, taken in conjunction with the accompanying drawings, wherein similar reference numerals denote similar elements, in which:

FIG. 1 is a schematic diagram showing an example of a configuration of which a reproducing apparatus according to an embodiment of the present invention is used;

FIG. 2 is an external view showing an example of a portable reproducing apparatus according to an embodiment of the present invention;

FIG. 3 is a block diagram showing an example of the structure of the reproducing apparatus;

FIG. 4 is a schematic diagram showing an outlined architecture applicable to the reproducing apparatus;

FIG. 5 is a schematic diagram showing an example of the structure of an attribute information table;

FIG. 6 is a flow chart showing an example of a process of which preview reproduction is automatically started;

FIG. 7A, FIG. 7B, FIG. 7C, and FIG. 7D are schematic diagrams showing examples of indications displayed on a display section according to the flow chart;

FIG. 8A and FIG. 8B are schematic diagrams describing a process performed when preview reproduction is switched to normal reproduction;

FIG. 9 is a flow chart showing an example of a process performed in an artist link mode;

FIG. 10A, FIG. 10B, and FIG. 10C are schematic diagrams showing examples of transitions of indications in the process of the artist link mode;

FIG. 11A, FIG. 11B, FIG. 11C, and FIG. 11D are schematic diagrams showing examples of transitions of indications in the process of the artist link mode; FIG. 12 a schematic diagram describing decryption and reproduction of subscription content;

FIG. 13 is a schematic diagram describing keys that are assigned to individual services;

FIG. 14A and FIG. 14B are schematic diagrams showing examples of structures of which licenses of subscription content are managed;

FIG. 15 is a flow chart showing an example of a process of notifying a user of a license expiration date of subscription content;

FIG. 16 is a schematic diagram describing a method of checking license information;

FIG. 17A and FIG. 17B are schematic diagrams showing examples of alarm indications denoting that an expiration date will come soon;

FIG. 18 is a schematic diagram showing the relationship among a license expiration date, reproducible and non-reproducible states of subscription content, and an alarm indication on a time axis; and

FIG. 19 is a schematic diagram showing another example of the configuration of which a reproducing apparatus according to an embodiment of the present invention is used.

### DETAILED DESCRIPTION OF THE PREFERRED EMBODIMENTS

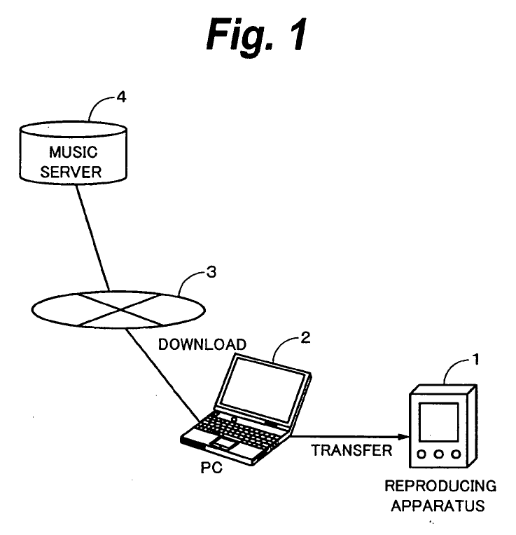

Next, with reference to the accompanying drawings, embodiments of the present invention will be described. FIG. 1 shows an example of a configuration of which a reproducing apparatus 1 according to an embodiment of the present invention is used. The reproducing apparatus 1 is a portable device (PD) structured with a small-size and light-weight housing. The reproducing apparatus 1 uses a hard disk drive as a record medium and reproduces content data from the record medium. In addition, the reproducing apparatus 1 has an interface which can communicate with a personal computer 2 (hereinafter referred to as the PC 2). The interface is for example the Universal Serial Bus (USB) or the Institute Electrical and Electronics Engineers (IEEE) 1394 interface. In this example, it is assumed that the reproducing apparatus 1 and the PC 2 are connected through the USB as a communication interface.

In the following description, it is assumed that content data recorded on the record medium of the reproducing apparatus 1 are song data, namely audio data. Each unit of song data is also referred to as a track.

A music server 4 provides for example a content data download service through the Internet 3. The music server 4 correlatively manages content data and attribute information for example artists, collected albums, and music genres. It is preferred that the music server 4 correlate content data with for example melody and tempo of songs as attribute information. In addition, the music server 4 manages ranking information on the basis of for example the download counts of tracks of content data and related information of artists (this information is referred to as artist link information). The music server 4 provides services using these kinds of information through the Internet 3. For example, the music server 4 adds these kinds of ranking information, artist link information, and so forth to the foregoing attribute information and provides the resultant attribute information to the user. The attribute information may include release dates of collected albums and content data.

The user connects for example the PC 2 to the Internet 3 and downloads content data from the music server 4 on the Internet 3. The downloaded content is stored in for example the hard disk drive of the PC 2. In addition, the user connects the reproducing apparatus 1 and the PC 2 with a USB cable and transfers content data stored in the hard disk drive of the PC 2 to the reproducing apparatus 1. The reproducing apparatus 1 records the transferred content data to an internal record medium thereof. Thereafter, the user disconnects the reproducing apparatus 1 from the PC 2.

The user can go out with the reproducing apparatus 1 and enjoy listening to content data which the reproducing apparatus 1 reproduces from the record medium.

When the user downloads content data from the music server 4, if he or she also obtains ranking information as attribute information, he or she can easily search for current popular content. In addition, if the user also obtains artist link information as attribute information, he or she can know other artists related to the selected content and easily search for content of the related artists. If the history of reproduced content data is stored in the reproducing apparatus 1, the user can easily search for his or her favorite content.

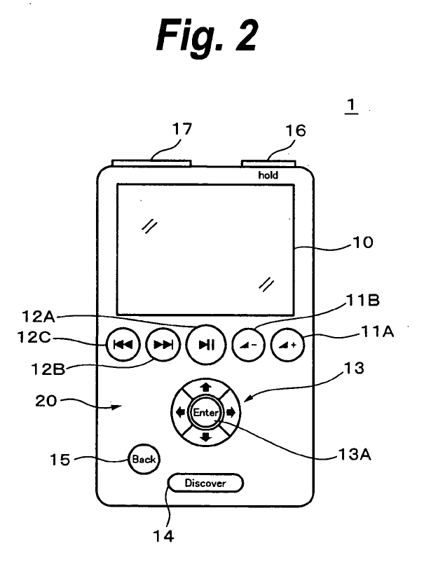

FIG. 2 shows an example of the appearance of the portable reproducing apparatus 1 according to this embodiment of the present invention. Disposed on the front surface of the reproducing apparatus 1 are mainly a display section 10 which is mainly composed of a liquid crystal display (LCD) as a display device and which displays information to the user and an operating section 20 which has a plurality of keys and which accepts user's operations. The display section 10 can perform a display control in the accuracy of for example one dot and display text, simple graphics, icons, and so forth.

Disposed on the front surface of the reproducing apparatus 1 are also a hold switch 16 and a connector section 17. The hold switch 16 switches operation states of the operating section 20 between “enable” and “disable”. The connector section 17 has a connector which is used to exchange data with an external device such as the PC 2 and a headphone terminal which outputs an analog audio signal reproduced by the reproducing apparatus 1.

Next, keys disposed on the operating section 20 will be described. When each key is for example pressed, a control signal corresponding to the key is output. In addition, different functions may be assigned to each key depending on whether it is pressed for a long time period or a short time period. In other words, different functions may be assigned to each key depending on whether the time period for which key is pressed is equal to or longer than a predetermined value (this state is referred to as the longly pressed state) or shorter than the predetermined value (this state is referred to as the shortly pressed state). When each key is shortly pressed, the assigned function is executed after the key is pressed and released in a predetermined time period. On the other hand, when a key is longly pressed, after it is pressed for a predetermined time period or longer, the assigned function is executed. If a key has been assigned only the shortly pressed state, when the key is pressed, the assigned function is executed. If a key is pressed for a predetermined time period or longer, this state can be defined as if the key were repeatedly pressed (this state is referred to as the key repeat state).

Keys 11A and 11B are sound volume keys with which the reproduced sound volume of content data is increased and decreased, respectively. Whenever the key 11A or 11B is shortly pressed, the sound volume is increased for one step. The keys 11A and 11B have the key repeat state.

Keys 12A, 12B, and 12C are keys with which reproduction of content data is controlled. Whenever the key 12A is shortly pressed, content data are commanded to be alternately reproduced and paused. When the key 12A is longly pressed, the operation mode of the reproducing apparatus 1 is switched to a sleep mode. When the key 12B is shortly pressed, the next content data are commanded to be reproduced. When the key 12B is longly pressed, the currently reproduced content data are commanded to be reproduced in a fast forward reproduction mode. Likewise, when the key 12C is shortly pressed, the preceding content data are commanded to be reproduced. When the key 12C is longly pressed, the currently reproduced content data are commanded to be reproduced in a fast backward reproduction mode.

A key block 13 has five direction keys which are an enter key 13A disposed at the center and arrow keys disposed around the enter key 13A. The arrow keys indicate up, down, left, and right (they are referred to as an up key, a down key, a left key, and a right key). The key block 13 allows the user to mainly operate a screen displayed on the display section 10.

While the display section 10 displays a screen on which content is being reproduced, when the enter key 13A is shortly pressed, the currently reproduced content is commanded to be alternately reproduced and paused. When the enter key 13A is shortly pressed again, the content is commanded to be reproduced again. While the display section 10 displays a screen other than the content reproduction screen, when the enter key 13A is pressed, an item selected on the screen is confirmed. While the display section 10 displays a list of tracks of content, when the enter key 13A is pressed, all content on the list is commanded to be reproduced.

When the up key and the down key of the key block 13 are shortly pressed, the currently selected item on the display section 10 is switched to the immediately upper item and the immediately lower item, respectively. When the up key and the down key are longly pressed, the list on the display section 10 is commanded to be quickly scrolled upward and downward, respectively. The key repeat function operates with the up key and the down key until they are longly pressed. Thus, with the up key and down key, the screen can be slowly scrolled for example upward and downward, respectively.

When the left key and right key of the key block 13 are shortly pressed, the currently selected item is switched to the immediately left item and the immediately right item, respectively. When the display section 10 displays a plurality of pages, the left key and the right key cause the current page to be switched to for example the next page and the preceding page, respectively. The left key and the right key do not have the longly pressed state. However, the key repeat function operates with the left key and the right key.

When a discovery key 14 is shortly pressed, an artist link function using artist link information is commanded to be called. When the discovery key 14 is longly pressed, the artist link function is called, causing content of all artists displayed on the display section 10 to be reproduced. Details of the artist link function will be described later.

When a key 15 is shortly pressed, the operation state of the reproducing apparatus 1 is commanded to be restored to the immediately preceding state. When the key 15 is longly pressed, the top menu is displayed on the display section 10.

The functions of the key block 13, the key 14, and the key 15 are examples. The functions of these key block and keys are not limited to these examples. Operation functions as software can be assigned to the key block 13 and the keys 14 and 15.

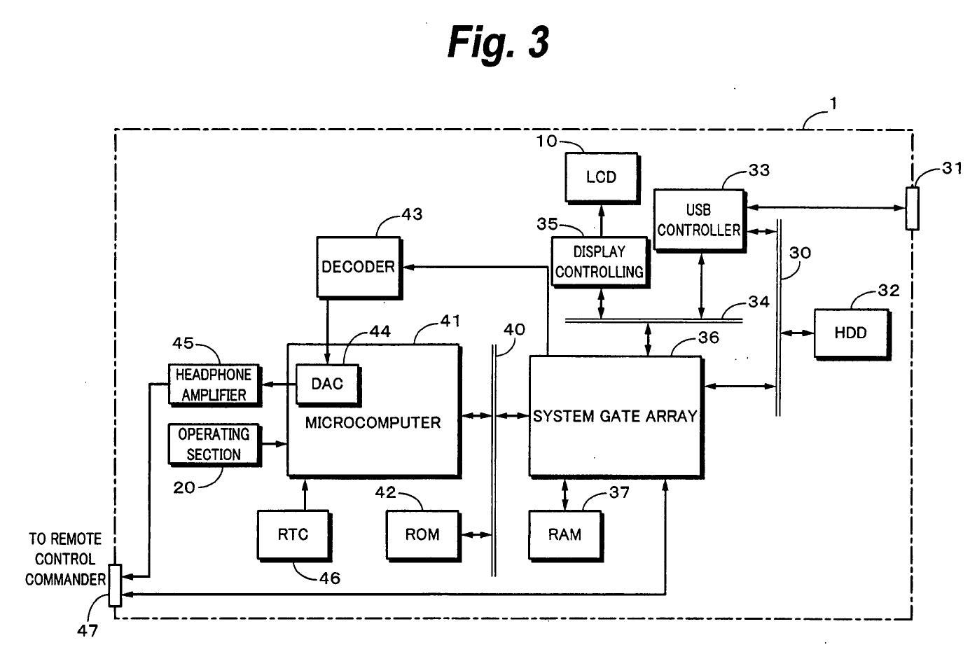

FIG. 3 shows an example of the structure of the reproducing apparatus 1. In the example shown in FIG. 3, the reproducing apparatus 1 has three buses 30, 34, and 40. Connected to the bus 30 are a hard disk drive (HDD) 32, a Universal Serial Bus (USB) controller 33, and a system gate array 36. The bus 30 mainly transfers content data. Connected to the USB controller 33 is a USB connector 31. The USB controller 33 controls communication with an external device connected to the USB connector 31.

Connected to the bus 34 are the USB controller 33, a display controlling section 35, and the system gate array 36. The bus 34 mainly transfers commands. The display controlling section 35 drives the display section 10 composed of for example an LCD with a display control signal supplied through the bus 34. The display controlling section 35 causes the display section 10 to display a screen corresponding to the display control signal.

Connected to the bus 40 are a microcomputer 41, the system gate array 36, and a Read Only Memory (ROM) 42. The bus 40 mainly transfers commands.

Connected to the microcomputer 41 are a Real Time Clock (RTC) 46 and the operating section 20. The operating section 20 generates control signals corresponding to the keys 11 to 15 and supplies the generated control signals to the microcomputer 41. The microcomputer 41 controls the entire reproducing apparatus 1 with control signals supplied from the operating section 20 according to a program pre-stored in for example the ROM 42. In addition, the microcomputer 41 generates predetermined display control signals according to the program.

The microcomputer 41 has an internal D/A converter (DAC) section 44. The DAC section 44 converts audio data supplied from a decoder (which will be described later) into an analog audio signal and supplies the analog audio signal to a headphone (HP) amplifier 45.

The ROM 42 is for example an Electrically Erasable Programmable Read Only Memory (EEPROM) which is a rewritable memory. The ROM 42 can update its stored program. A program to be updated is supplied from for example an external computer device through the USB connector 31.

Since the microcomputer 41 controls the reproducing apparatus 1 according to the program stored in the ROM 42, it can be considered that the reproducing apparatus 1 is substantially a computer device.

The system gate array 36 controls exchanging of data and commands among the buses 30, 34, and 40. Connected to the system gate array 36 are a RAM 37 and a decoder 43. The decoder 43 decodes audio data which have been compression-encoded. The RAM 37 is used as a work memory of the microcomputer 41. In addition, the RAM 37 is used as a buffer for audio data which the decoder 43 decodes. The RAM 37 has a storage capacity of for example 16 Mega Bytes (MB). Among 16 MB, a predetermined area of 12 MB is allocated as a buffer memory area for audio data.

Connected to a remote control terminal 47 is a remote control commander which wirelessly and remotely controls the reproducing apparatus 1 and has a headphone terminal. An analog audio signal which is output from the headphone amplifier 45 is supplied to the remote control terminal 47. In addition, the system gate array 36 and the remote control terminal 47 are connected. A control signal corresponding to an operation for the remote control commander is input from the remote control terminal 47 and is supplied to the microcomputer 41 through the system gate array 36 and the bus 40.

The foregoing USB connector 31 and remote control terminal 47 are disposed on the connector section 17 as shown in FIG. 2. The hold switch 16 is connected to the operating section 20 (not shown).

In the foregoing description, the reproducing apparatus 1 and the PC 2 are wire-connected. However, this structure is just an example. Instead, a wireless communication I/F (not shown) which controls wireless communication may be connected to the bus 30. The wireless communication I/F may allow the reproducing apparatus 1 and the PC 2 to wirelessly exchange commands therebetween and the PC 2 to wirelessly transfer content data and so forth to the reproducing apparatus 1.

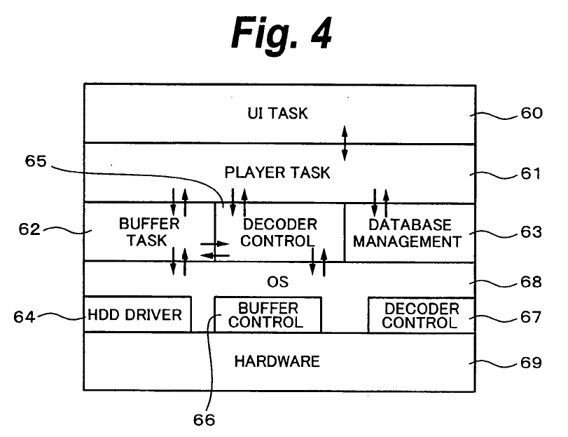

FIG. 4 schematically shows an architecture applicable to the reproducing apparatus 1. A User Interface (UI) task 60 accomplishes a user interface which causes the display section 10 to display data and generates control signals corresponding to operations of the operating section 20. The UI task 60 for example controls a cursor indication 70 corresponding to operations of the key block 13 of the operating section 20 and generates control commands corresponding to operations of the keys 12A to 12C with which reproduction of audio data is controlled. The reproduction control commands are play (reproduction), stop (reproduction stop), feed forward (fast forward with reproduction), rewind (rewind with reproduction), cue (fast forward without reproduction), review (rewind without reproduction), pause (reproduction pause), and so forth.

A player task 61 is placed below the UI task 60. The player task 61 manages reproduction of content data. The player task 61 exchanges data with a database (which will be described later) corresponding to a command received from the UI task 60, grasps content to be reproduced, and issues a content data reproduction control command to lower tasks. In addition, the player task 61 regularly grasps the current play mode, returns the play mode to the UI task 60, and controls reproduction corresponding to the play mode.

The play mode is an operation mode with respect to reproduction order of tracks of content. The play mode is categorized as for example a normal mode of which tracks of content are reproduced in the order of a list, a shuffle mode of which the reproduction order of tracks of content is randomly changed, and so forth.

A buffer task 62, a database (DB) management task 63, and a decoder control task 65 are placed below the player task 61. The buffer task 62 controls reading and writing of data from and to a buffer memory area of the RAM 37. In addition, the buffer task 62 controls reading of audio data from the hard disk drive 32. In addition, the buffer task 62 analyzes header information of audio data stored in the buffer memory. The buffer task 62 controls the buffer memory as a ring buffer of which its top address and its last address are logically connected.

The database management task 63 manages content data recorded in the hard disk drive 32. The database management task 63 correlatively manages for example identification information (ID) with which content data recorded in the hard disk drive 32 are identified, information representing record positions of the content data, and attribute information of the content data. In addition, the database management task 63 manages artist link information. Details of a database managed by the database management task 63 will be described later.

The decoder control task 65 controls a decoding process which the decoder 43 performs for audio data. The control of the decoder control task 65 is interlocked with the process of for example the buffer task 62.

An Operating System (OS) 68 integrally manages the UI task 60, the player task 61, the buffer task 62, the decoder control task 65, and the database management task 63, which are upper tasks of the OS 68. In addition, the OS 68 provides fundamental functions of software to each task. For example, the OS 68 provides a file system which manages files recorded in the hard disk drive 32 to each upper task. The file system manages each logical address of the record area of the hard disk drive 32 and files in the hard disk drive 32. The file system provides a scheme for reading and writing of data from and to the hard disk drive 32.

In addition, the OS 68 manages each component of hardware that composes the reproducing apparatus 1. The OS 68 performs an intermediate process between the upper tasks and hardware 69 of the reproducing apparatus 1. The OS 68 has for example an HDD driver 64 which controls the hard disk drive 32, a buffer controlling section 66 which controls reading and writing of data from and to the buffer memory area of the RAM 37, and a decoder controlling section 67 which controls the decoder 43.

The OS 68 and the tasks 60 to 65 shown in FIG. 4 are accomplished by operations of the microcomputer 41 according to a program stored or recorded in the ROM 42 and/or the hard disk drive 32.

In such a structure, when the reproducing apparatus 1 and the PC 2 are connected with a USB cable, the USB controller 33 exchanges data with the PC 2 in a predetermined manner so that the PC 2 recognizes the reproducing apparatus 1 as a removable hard disk drive. In other words, the PC 2 can record content data recorded in the hard disk drive of the PC 2 to the hard disk drive of the reproducing apparatus 1 using a file copy function which the OS of the PC 2 provides.

The PC 2 transmits content data and commands to the reproducing apparatus 1 through the USB cable. The content data and commands are received by the USB controller 33. The received content data are transferred by the USB controller 33 to the hard disk drive 32 through the bus 30 and written to the hard disk drive 32. In addition, the received commands are captured from the USB controller 33 to the microcomputer 41 through the system gate array 36.

Next, a process for reproduction will be described. For example, the microcomputer 41 references a database for content recoded in the hard disk drive 32 and generates a display control signal with which a list of content is displayed. The display control signal is supplied to the display controlling section 35 through the system gate array 36 and the bus 34. The display controlling section 35 converts the display control signal into a drive signal with which the display section 10 is driven. The drive signal is supplied to the display section 10. The display section 10 displays a list of content data which can be reproduced corresponding to the display control signal.

The user operates the operating section 20 corresponding to for example data displayed on the display section 10 in a predetermined manner and selects content data which he or she wants to reproduce. The operating section 20 outputs a control signal corresponding to the user's operation. The microcomputer 41 monitors the control signal which is output from the operating section 20. When the microcomputer 41 has obtained a control signal representing a reproduction command, the microcomputer 41 issues a command causing the selected content data to be reproduced. This command is transmitted to the hard disk drive 32 through the system gate array 36 and the bus 30.

Content data which have been read from the hard disk drive 32 are supplied to the system gate array 36 through the bus 30. The system gate array 36 stores the supplied content data in the buffer memory area of the RAM 37. In addition, the system gate array 36 reads a predetermined amount of content data stored in the buffer memory area of the RAM 37 and transfers the content data to the decoder 43. The microcomputer 41 monitors the amount of content-data stored in the buffer memory area. When the amount of data stored in the buffer memory area becomes a predetermined amount or less, the microcomputer 41 issues a content data read command to the hard disk drive 32 through the system gate array 36 and the bus 30.

The decoder 43 decodes the transferred content data and transfers them as baseband audio data to the microcomputer 41. When necessary, the microcomputer 41 performs a predetermined acoustic process for the audio data transferred from the decoder 43. The DAC section 44 converts the resultant digital audio data into analog audio data and outputs the analog audio data as an analog audio signal. The analog audio signal is supplied to the HP amplifier 45. The HP amplifier 45 performs an amplifying process for the analog audio signal and supplies the amplified analog audio signal to the remote control terminal 47.

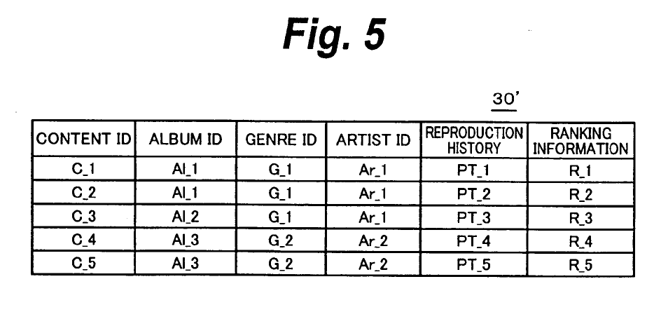

Next, the database with which content data recoded in the hard disk drive 32 are managed will be described. This database is managed by the foregoing database management task 63. FIG. 5 shows an example of the structure of an attribute information table of the database. With the attribute information table, attribute information of content data is managed. In the example shown in FIG. 5, each record of the attribute information table has a field “content ID”, a field “album ID”, a field “genre ID”, a field “artist ID”, a field “reproduction history”, and a field “ranking information”.

In the example shown in FIG. 5, pointer information corresponding to real data is stored as an ID in each field of each record. For example, each field of each record stores pointer information to a record of another table which stores real data. As a result, a relational database is structured. A content ID is unique to each content data. Each record of the attribute information table is correlated with real content data using a content ID. The structure of the database is not limited to this example. Instead, real data may be stored in each field other than the field “content ID”.

In the attribute information table, whenever content data correlated with a particular record are reproduced, the value of the field “reproduction history” of the record is incremented by 1. It is preferred that the ranking information be updated at predetermined timing. For example, when new content data are downloaded from the music server 4 to the PC 2, ranking information corresponding to the content data stored in the PC 2 is also downloaded. When the content data are transferred from the PC 2 to the reproducing apparatus 1, the ranking information may be also transferred so that the database is updated.

The database management task 63 also manages the artist link information. The artist link information is what for example artist A is correlated with information of artist B, artist C, and so forth who are related to artist A. For example, if artist A created album Z in collaboration with artist B and artist C, it can be said that artist B and artist C are related artists of artist A. In addition, artist A may be correlated with other artists with respect to a style of artist A. For example, artist A may be correlated with other artists with respect to melody and tempo of main content of artist A. In addition, artist A may be correlated with other artists with respect to years in which artist A actively worked. In addition, information of artists may be correlated with respect to a plurality of kinds of information of related artists.

Artist link information may be assigned in different levels corresponding to related degrees of objective artists. Artist A may be correlated with first artist link information which is composed of information of for example artists B, C, D, and so forth who are strongly related to artist A and second artist link information which is composed of information of artists Q, P, Q, and so forth who are weakly related to artist A. For example, these two types of tables are created for artist information managed by the database management task 63. All artist information managed by the database management task 63 may be arranged as matrix elements and related degrees may be assigned to the matrix elements. The structure of the artist link information is not limited to these examples.

The artist link information is provided as a service of for example the music server 4 side to the user. The artist link information is downloaded from the music server 4 to the PC 2 through the Internet 3. The artist link information is transferred from the PC 2 to the reproducing apparatus 1 and then recorded to the hard disk drive 32. For example, a list of content recoded in the hard disk drive of the PC 2 and the hard disk drive 32 of the reproducing apparatus 1 is transmitted from the PC 2 to the music server 4. The music server 4 references attribute information corresponding to the list of content, creates artist link information, and transmits it to the PC 2. Instead, the user side may create artist link information.

According to this embodiment of the present invention, if the cursor indication has been placed at a position of particular content for a predetermined time period, the particular content is selected and a predetermined portion thereof is automatically reproduced. In the following description, an operation of which only a predetermined portion of content is selectively reproduced is referred to as the preview reproduction. On the other hand, an operation of which the entire content is reproduced is referred to as the normal reproduction. A method of performing the preview reproduction will be described later.

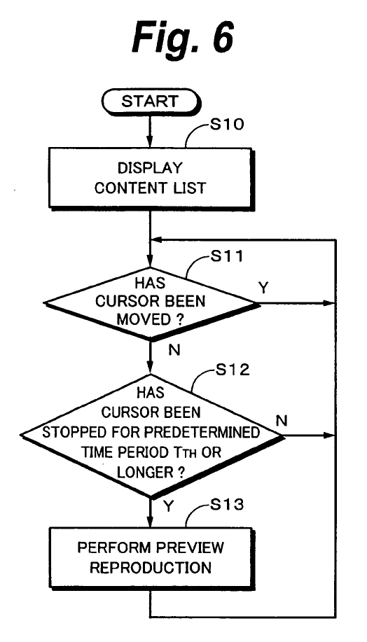

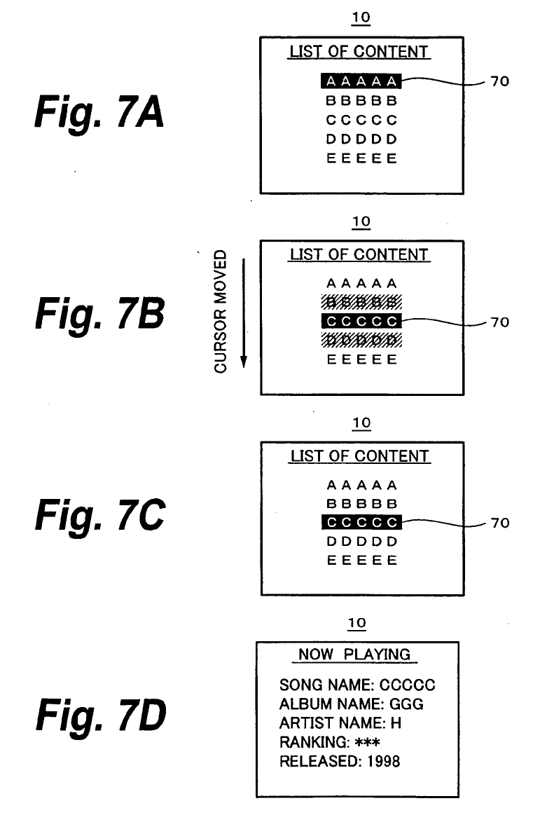

FIG. 6 is a flow chart showing a process of automatically performing the preview reproduction. FIG. 7A to FIG. 7D show examples of indications which are displayed on the display section 10 according to the flow chart shown in FIG. 6. A content list is displayed on the display section 10 (at step S10). For example, as shown in FIG. 7A, a list of content names is displayed on the display section 10. The cursor indication 70 is displayed at its home position.

The cursor indication 70 is displayed as follows. For example, the microcomputer 41 generates a display control signal which causes the cursor indication to be displayed at a predetermined position. The display control signal is supplied to the display controlling section 35 through the system gate array 36 and the bus 34. The display controlling section 35 drives the display section 10 corresponding to the display control signal. As a result, the cursor indication 70 is displayed. The position of the cursor indication 70 is moved and designated by operating for example the up key and/or down key of the key block 13.

In the example shown in FIG. 7A to FIG. 7D, the cursor indication 70 is generated by inverting the display color of a content name. However, the display method of the cursor indication 70 is not limited to this example. In other words, as long as the cursor indication is displayed at a position of a content name, any method may be used. For example, the cursor indication may be a predetermined mark which is displayed at the beginning of a content name.

At step S11, it is determined whether the cursor indication 70 has been moved. For example, when the user has not performed a key input with for example the up key and down key of the key block 13 and the cursor indication 70 does not move, the flow advances to step S12. At step S12, the microcomputer 41 measures a time period T for which the cursor indication 70 has stopped at the position of any content name and determines whether the time period T exceeds a predetermined time period Tₜₕ. As shown in FIG. 7B, when the cursor indication 70 has moved to the position of a content name “CCCCC”, the microcomputer 41 starts counting the time period T corresponding to an output of the RTC 46. Before the time period T exceeds the predetermined time period Tₜₕ, the microcomputer 41 determines whether the cursor indication 70 has moved from the position of the content name “CCCCC” to another position.

The predetermined time period Tₜₕ is for example around 0.5 seconds. It is preferred that the value of the predetermined time period Tₜₕ be changed by the user.

When the determined result at step S12 denotes that the time period T exceeds the predetermined time period Tₜₕ, the flow advances to step S13. At step S13, a part of content at the position of the current cursor indication 70 is reproduced. For example, when the cursor indication 70 has been moved to the position of a content name “CCCCC” shown in FIG. 7B and stopped at the position for the predetermined time period Tₜₕ or longer, a part of content data having the content name “CCCCC” is reproduced. The preview reproduction is performed for content having the content name “CCCCC”.

In the preview reproduction, content data are reproduced from the beginning for a predetermined time period (for example, 10 seconds). Instead, after real content data are reproduced from the beginning for a predetermined time period, the reproduction may be stopped. Instead, a dedicated file for the preview reproduction may be created and the file may be reproduced. Instead, a preview reproduction position may differ in each content. The dedicated file for the preview reproduction may be automatically created when content data are recorded to the hard disk drive 32.

After the preview reproduction for particular content has been completed, the preview reproduction for content at the next position may be automatically started. In FIG. 7A to FIG. 7D, after the preview reproduction for the content name “CCCCC” has been completed and the cursor indication 70 has not been moved, the preview reproduction for content having the next content name “DDDDD” may be automatically started.

In addition, while the preview reproduction is being performed, the cursor indication 70 may be moved by a key operation. In this case, when the cursor indication 70 is moved to the position of another content name and stopped for the predetermined time period Tₜₕ or longer, the preview reproduction may be performed for content at the position of the cursor indication 70.

For example, as shown in FIG. 7C, while the preview reproduction is being performed for content having the content name “CCCCC”at the position of the cursor indication 70, it is moved by a key operation. The cursor indication 70 is moved through the position of content name “DDDDD” within the predetermined time period Tₜₕ and then stopped at the position of the content name “EEEEE”. The microcomputer 41 measures the stop time period T of the cursor indication 70. When the stop time period T exceeds the predetermined time period Tₜₕ, the microcomputer 41 stops the preview reproduction for content having the content name “CCCCC” and starts the preview reproduction for content having the content name “EEEEE”.

When a confirmation operation is performed for the selected content while the preview reproduction is being performed, the preview reproduction can be switched to the normal reproduction. When the preview reproduction is switched to the normal reproduction, the display section 10 displays an indication which describes that the normal reproduction is being performed as exemplified in FIG. 7D. In the example shown in FIG. 7D, the display section 10 displays text “Now Playing” which indicates that the normal reproduction is being performed. In addition, the display section 10 displays attribute information of content having the content name “CCCCC”, which is being reproduced.

Next, while the preview reproduction is being performed, when for example the enter key 13A is pressed, the selected content is confirmed. As a result, the preview reproduction is switched to the normal reproduction. Next, the process of switching from the preview reproduction to the normal reproduction will be described. In this case, there are two methods. In the first method, the normal reproduction is performed from the beginning of content data for which the preview reproduction was performed. In the second method, the normal reproduction is performed from the position of content data at which the preview reproduction was stopped.

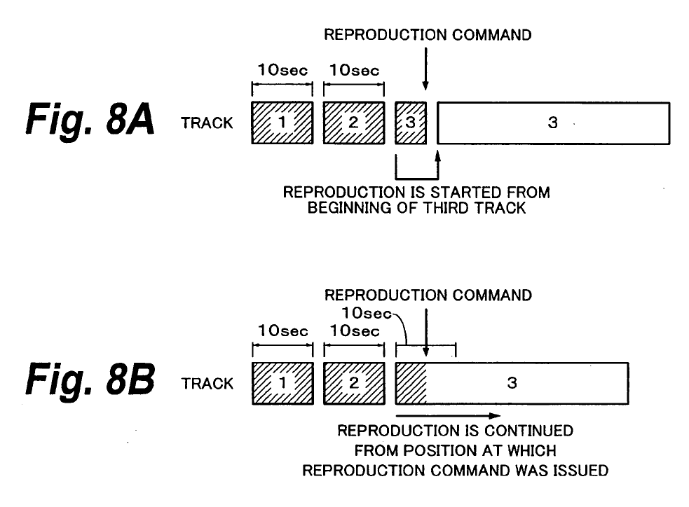

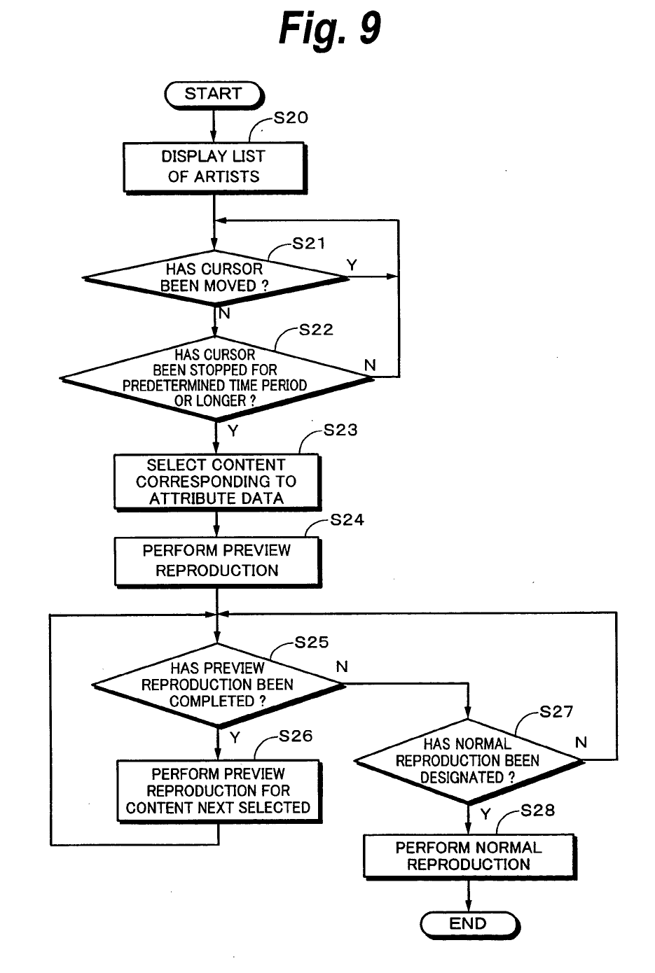

Next, with reference to FIG. 8A and FIG. 8B, these methods will be described in brief. It is assumed that the time period for which the preview reproduction is performed is 10 seconds from the beginning of content, that the preview reproduction is successively and automatically performed for first, second, and third tracks of content data, and that the confirmation operation is performed in the middle of the preview reproduction for the third track.

In the first method, as shown in FIG. 8A, when the confirmation operation is performed by operating for example the enter key 13A while the preview reproduction is being performed for the third track (the reproduction operation is commanded), the preview reproduction for the third track is stopped. After a predetermined time period has elapsed, the whole third track of content data is reproduced from the beginning.

On the other hand, in the second method, as exemplified in FIG. 8B, when the confirmation operation is performed while the preview reproduction is being performed for the third track, the preview reproduction is stopped. The normal reproduction is successively performed from the position at which the preview reproduction for the third track was stopped.

In the foregoing description, a list of content recorded in the hard disk drive 32 is directly displayed on the display section 10. However, that structure is just an example. In other words, several hundred tracks to several thousand tracks of content data can be recorded in the hard disk drive 32. With the automatic preview reproduction corresponding to the stop time period of the cursor indication 70 and the content attribute information, content can be easily retrieved from such a large amount of data.

Next, as an example of the preview reproduction, a method of selecting content data using the foregoing artist link information will be described. In the following description, a mode of which content is selected using artist link information is referred to as the artist link mode.

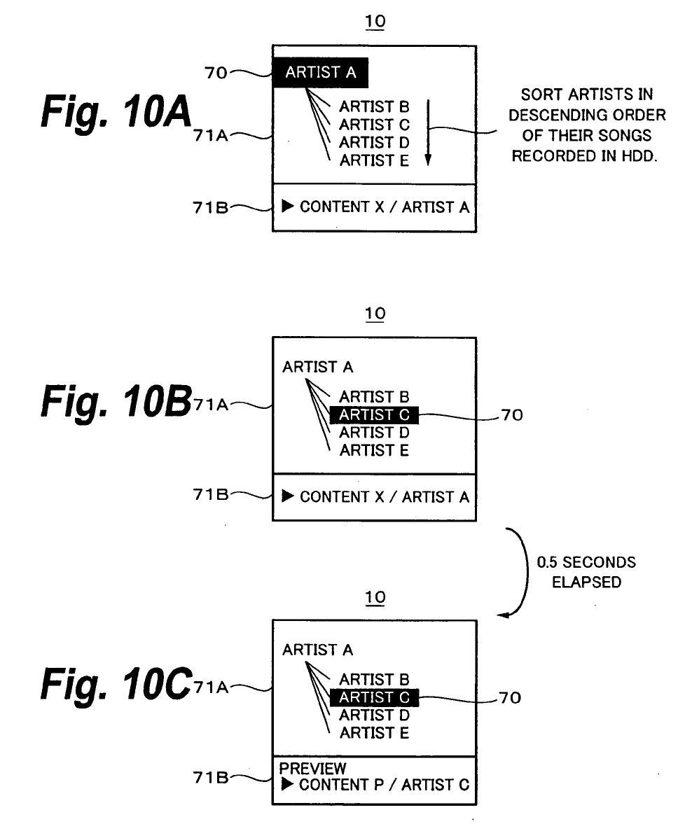

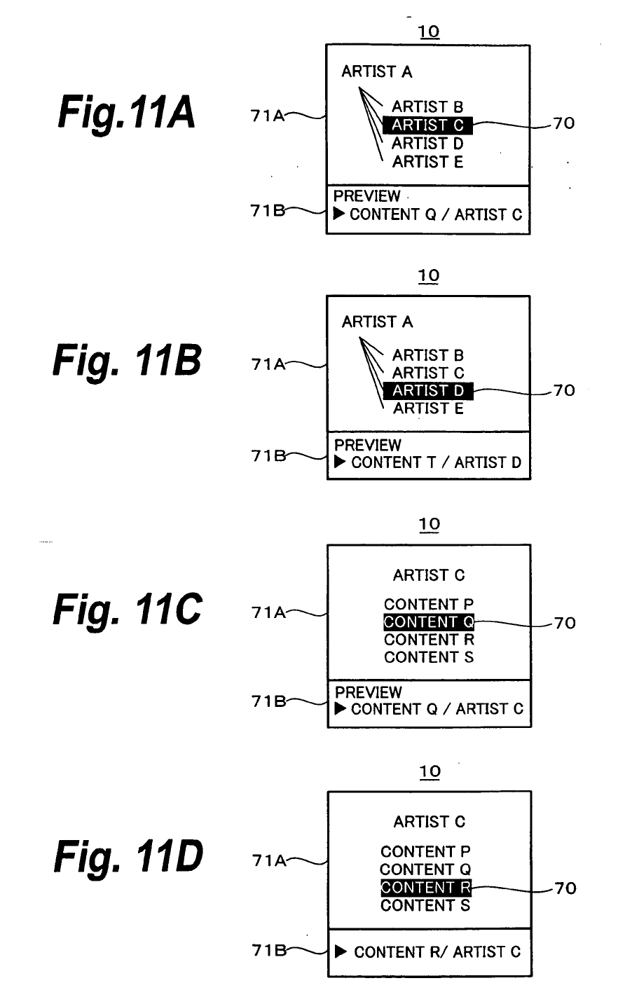

FIG. 9 is a flow chart showing an example of a process preformed in the artist link mode. FIG. 10A to FIG. 10C and FIG. 11A to FIG. 11D show examples of transitions of indications in the process shown in FIG. 9. It is assumed that the reproduction operation mode of the reproducing apparatus 1 is the normal reproduction mode and that the normal reproduction is being performed for content X of artist A. When for example the discovery key 14 of the operating section 20 is operated, the artist link mode takes place. When the artist link mode takes place, the microcomputer 41 references artist link information and causes the display section 10 to display an artist link screen as shown in FIG. 10A. The artist link screen has a list indication portion 71A which indicates a list of artist A and artists B, C, and so forth related to artist A (at step S20).

In this example, with reference to attribute information table, artist names are sorted and listed in the descending order of the number of tracks of contents recorded in the hard disk drive 32. The cursor indication 70 is displayed at the position of artist A. A reproduction content indication portion 71B indicates content information which is currently being reproduced. The sorting order of artist names is not limited to this example. While the cursor indication 70 is displayed at the position of artist A, the normal reproduction is continued for content that was being reproduced in the normal reproduction mode immediately before the artist link mode took place (in this example, content X of artist A).

In this state, when the down key of the key block 13 is operated, as shown in FIG. 10B, the cursor indication 70 is successively moved to the positions of the related artists B, C, and so forth (at step S21). In addition, the artist link mode is switched to the preview reproduction mode. In the example shown in FIG. 10B, the cursor indication 70 is stopped at the position of artist C through the position of artist B within a predetermined time period (for example, 0.5 seconds) corresponding to the user's operation with the down key.

According to the measured result of the microcomputer 41, it is determined whether the cursor indication 70 has been stopped at the position of artist C for the predetermined time period Tₜₕ or longer (at step S22). When the determined result denotes that the stop time period T is equal to or longer than the predetermined time period Tₜₕ, the flow advances to step S23. At step S23, with reference to the attribute information table 30′, content is automatically selected from content data related to the item at the position of the cursor indication 70 according to a predetermined rule.

For example, as shown in FIG. 10B, it is assumed that the cursor indication 70 is displayed at the position of an item “artist C” and content P, Q, R, and S have been recorded as content of artist C in the hard disk drive 32. These content P, Q, R, and S are sorted in the descending order of their ratings according to the attribute information table 30′. For an item of the ratings, the field “reproduction history” of the attribute information table 30′ is used. Content is sorted in the descending order of their reproduction counts. Content may be sorted in the order of their popularities using the field “ranking information” of the attribute information table 30′. Instead, content may be rated with their favorites according to their reproduction counts and their skip counts. It is preferred that the user freely assigns an item to be rated. At step S23, the microcomputer 41 automatically selects content P which is the highest rated content.

Thereafter, the flow advances to step S24. At step S24, the preview reproduction for the selected content P is performed. At step S24, the display section 10 still displays the artist link screen. The reproduction content indication portion 71B indicates content for which the preview reproduction is being performed (see FIG. 10C).

Thereafter, the flow advances to step S25. At step S25, while the cursor indication 70 is displayed at the position of artist C, it is determined whether the preview reproduction for content P has been completed. When the determined result at step S25 denotes that the preview reproduction for content P has been completed, the flow advances to step S26. At step S26, the preview reproduction for the next selected content is automatically performed. The preview reproduction for the next highly ranked content after content P (for example, content Q) is automatically performed. The display section 10 still displays the artist link screen. The reproduction content indication portion 71B indicates content for which the preview reproduction is being preformed (see FIG. 11A). Thereafter, the flow returns to step S25.

After the preview reproduction for all content recorded in the hard disk drive 32 for artist C at the position of the cursor indication 70 has been completed, the preview reproduction for content of the next artist (for example, artist D) is automatically performed (step S25 and step S26 are repeated). At this point, the display section 10 still displays the artist link screen. In the list indication portion 71A, the cursor indication 70 is automatically moved to the position of artist D (see FIG. 11B). The reproduction content indication portion 71B indicates content T for which the preview reproduction is currently being performed.

In contrast, when the determined result at step S25 denotes that the preview reproduction is being performed, the flow advances to step S27. At step S27, it is determined whether to switch the preview reproduction mode to the normal reproduction mode.

When the confirmation operation is performed with for example the enter key 13A in the state shown in FIG. 11A, the artist link screen is switched to the content list screen on the display section 10 as shown in FIG. 11C. Content of artist C can be selected on the content list screen. The list indication portion 71A on the content list screen indicates a list of content of artist C. The reproduction content indication portion 71B on the content list screen indicates content for which the preview reproduction is currently being performed.

When the confirmation operation for content is performed with for example the enter key 13A in the state shown in FIG. 11B, it is determined that the reproduction mode be switched to the normal reproduction mode. The flow advances to step S28. At step S28, the normal reproduction is performed for content Q for which the preview reproduction is currently being performed. The display section 10 still displays the content list screen. The reproduction content indication portion 71B on the content list screen indicates content selected for the normal reproduction (FIG. 11C). After the normal reproduction is preformed for content Q, the value of the field “reproduction history” of the record corresponding to content Q on the attribute information table 30′ is incremented by 1.

Unless the normal reproduction is commanded, the flow returns to step S25. At step S25, the preview reproduction is continued. After the preview reproduction for content Q has been completed, if the cursor indication 70 is not moved, the preview reproduction for content R which is the next highest rated content is automatically started. The cursor indication 70 is moved to the position of content R.

When the determined result at step S25 denotes that the preview reproduction is being performed, in the state of which the artist link screen shown in FIG. 11A is displayed, by moving the cursor indication 70, another artist can be selected. In other words, when the determined result at step S25 denotes that the preview reproduction is being performed and the cursor indication 70 has been moved, the flow returns to step S23. At step S23, the preview reproduction for content of an artist at the position of the cursor indication 70 can be performed.

Next, a method of notifying a user of an expiration date for subscription content according to an embodiment of the present invention will be described. First, a service which provides subscription content will be described in brief. Subscription content is content which a user can reproduce for a predetermined time period when he or she pays a flat fee to the service provider side for the content.

For example, the user pays a flat fee to the service provider side (for example, the music server 4) and makes a predetermined service contract with the service provider side. On the other hand, the service provider side encrypts content in a predetermined manner and holds it as subscription content. The service provider side permits the contracted user to download subscription content and sends a decryption key with which the contracted user can decrypt the subscription content to him or her through for example the Internet. This key is assigned an expiration date. After the expiration date of the key has come, encrypted content is not able to be decrypted with the key.

The user records the downloaded subscription content and the key of the subscription content to the reproducing apparatus 1. When the user selects the reproduction of downloaded subscription content, the reproducing apparatus 1 decrypts the subscription content with the key and reproduces the decrypted subscription content. When the expiration date of the key of the subscription content will come soon or after the expiration date has come, the reproducing apparatus 1 causes the display section 10 to display for example an alarm message which notifies the user that the expiration date of the key will come soon or has come.

In other words, as exemplified in FIG. 12, encrypted content 100 recorded in the reproducing apparatus 1 is decrypted with a key 101 to which an expiration date has been assigned before the expiration date comes. The decrypted content is reproduced. The expiration date of the key 101 is managed by a secure clock 102 whose time is not able to be changed by the user.

When the encrypted content 100 is reproduced, the time assigned to the key 101 and the current time counted by the secure clock 102 are compared. When the current time is earlier than the time assigned to the key 101, the encrypted content 100 is decrypted with the key 101. In contrast, when the current time is later than the time assigned to the key 101, the encrypted content 100 is not decrypted with the key 101.

When the expiration date of the key of the subscription content has come, the user can pay a predetermined fee to the content provider side to extend the expiration date. As a result, the encrypted content 100 can be decrypted with the key 101. Thus, the subscription content can be reproduced.

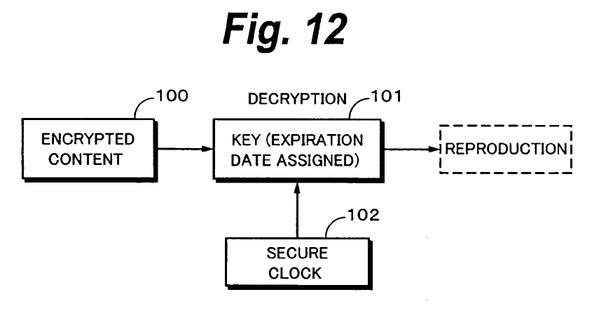

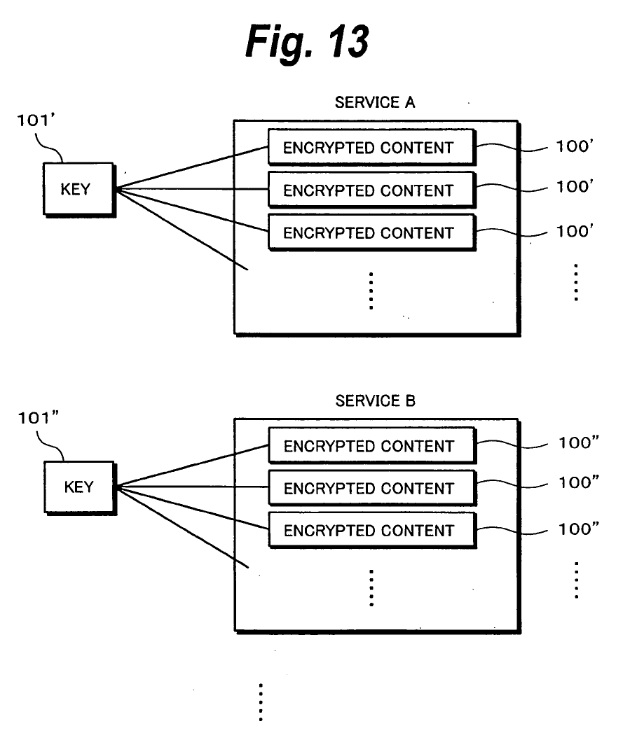

It should be noted that the relationship between the encrypted content 100 and the key 101 with which the encrypted content 100 is decrypted is not limited to the relationship of one to one as exemplified in FIG. 12. For instance, as exemplified in FIG. 13, the key 101 may be assigned to each of services which the service provider side provides.

In this case, a plurality of encrypted content 100′, 100′, and so forth downloaded as service A are decrypted with a common key 101′. Likewise, a plurality of encrypted content 100″, 100″, and so forth downloaded as service B are decrypted with a common key 101″, which is different from the key 101′. Expiration dates are assigned to the key 101′ and the key 101″ for service A and service B, respectively.

In the method shown in FIG. 13, the expiration dates of the keys 101′, 101″, and so forth for the services can be retrieved. Thus, the method shown in FIG. 13 is easier than the method of which each content has the key 101. In addition, keys may be hierarchically assigned.

According to an embodiment of the present invention, only when the user turns on the power of the reproducing apparatus 1 and the reproducing apparatus 1 gets started, it notifies him or her that the expiration date of a key of content will come soon. When the reproducing apparatus 1 gets started, it retrieves subscription content from content recorded in the hard disk drive 32 of the reproducing apparatus 1 and checks the expiration date of the subscription content. The reproducing apparatus 1 compares the checked expiration date with the current time (date). If there is subscription content whose expiration date will come soon, the reproducing apparatus 1 causes the display section 10 to display the subscription content whose expiration date will come soon. Thus, the user can know whether there is subscription content whose expiration date will come soon before he or she selects the subscription content.

If the reproducing apparatus 1 notifies the user that there is subscription content whose expiration date will come soon only when he or she starts up the reproducing apparatus 1 first time every day, it is preferred that since he or she is not notified that there is subscription content whose expiration date will come soon whenever he or she turns on the power of the reproducing apparatus 1, he or she do not feel bothersome.

Next, the method of notifying the user of an expiration date of subscription content according to this embodiment of the present invention will be described in more detail. In the following description, as shown in FIG. 13, it is assumed that downloaded subscription content is managed on the basis of each service and that a key 101″ with which encrypted subscription content is decrypted is assigned on the basis of each service. In addition, under a service contract which the user made with the content provider side, it licenses the user to use the service.

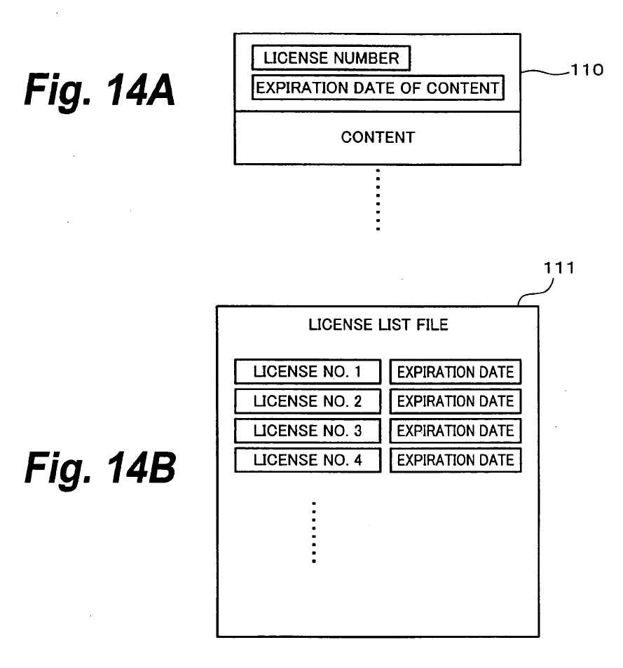

FIG. 14A and FIG. 14B show examples of structures of which a license of subscription content is managed. As exemplified in FIG. 14A, each subscription content has license management information 110 composed of a license number and expiration date information representing an expiration date of the subscription content. The license number denotes a service to which the subscription content belongs. The license management information 110 is stored in for example a header portion of the subscription content. Instead, the license management information 110 may be a file correlated with each subscription content in a predetermined manner.

FIG. 14B shows an example of a license list file 111 describing license information for each service. In the example shown in FIG. 14B, license numbers of contracted services and expiration date information representing expiration dates of downloadable subscription content are correlatively described. A license number is uniquely generated on the basis of each service by for example the reproducing apparatus 1. In addition, a key with which encrypted subscription content downloaded on the basis of a service corresponding to a license number is decrypted is correlated with the license number (not shown).

When the user contracts with the service provider side for a service, the service provider side supplies license information described in the license list file 111 to the user. The license information is recorded to the hard disk drive 32 of the reproducing apparatus 1. When the user contracts with the service provider side for a new service, a license number and expiration date information are added to the license list file 111. As a result, the license list file 111 is updated.

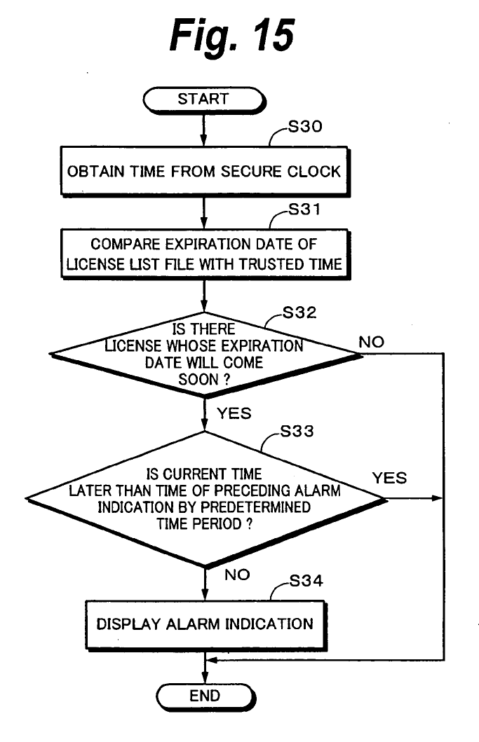

FIG. 15 is a flow chart showing an example of a process of notifying a user of an expiration date of subscription content according to an embodiment of the present invention. When the reproducing apparatus 1 gets started, the flow advances to step S30. At step S30, the current time is obtained from the secure clock. As described above, the secure clock is a clock whose time is not able to be changed by the user. The secure clock may be composed of for example the real time clock 46. Time information obtained from the secure clock is referred to as trusted time.

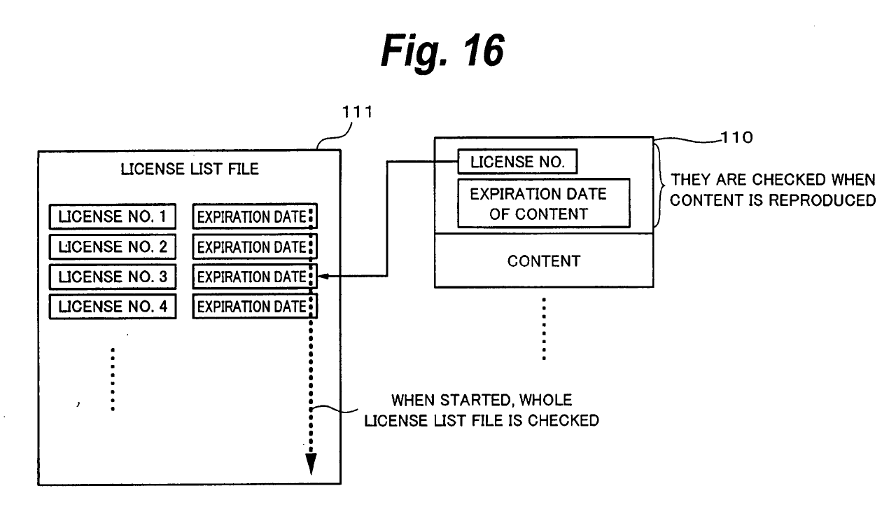

Thereafter, the flow advances to step S31. At step S31, the license list file 111 is read from the hard disk drive 32 according to a command issued from the microcomputer 41. The microcomputer 41 compares the expiration date information described in the license list file 111 with the trusted time. As exemplified on the left of FIG. 16, when the reproducing apparatus 1 gets started, the entire license list file 111 is checked and each entry of expiration date information described in the license list file 111 and the trusted time are compared.

Thereafter, the flow advances to step S32. At step S32, the microcomputer 41 determines whether there is a license whose expiration date will come soon according to the compared result at step S31. For example, if the trusted time is earlier than an expiration date of the expiration date information by a predetermined time period, it is determined that the expiration date of the license corresponding to the expiration date information will come soon. When the determined result denotes that there is no license whose expiration date will come soon, the sequence of steps of the process is completed. In contrast, when the determined result at step 32 denotes that there is a license whose expiration date will come soon, the flow advances to step S33.

The predetermined time period may be assigned on day basis, for example five days or seven days. Instead, the predetermined time period may be assigned on hour basis, for example 120 hours or 168 hours. Instead, the predetermined time period of each license may be different from each other. In this case, the service provider side pre-assigns the predetermined time period and supplies it to the user along with license information.

At step S33, the current time and a time at which the alarm indication was displayed according to the sequence of steps of the process are compared. It is determined whether the current time is later than the time at which the preceding alarm indication was displayed by the predetermined time period or longer. When the determined result denotes that the current time is later than the time at which the preceding alarm indication was displayed by the predetermined time period or longer, the flow advances to step S34. At step S34, the display section 10 displays the predetermined alarm indication.

In contrast, when the determined result denotes that the current time is not later than the time at which the preceding alarm indication was displayed by the predetermined time period or longer, the sequence of steps of the process is completed. Thus, the display section 10 does not display the alarm indication. When the power of the reproducing apparatus 1 is frequently turned on and off in a relatively short period, the determination at step S33 allows the display section 10 to display the alarm indication only when the reproducing apparatus 1 gets started first time every day. In this case, after the power of the reproducing apparatus 1 has been turned off and a predetermined time period has elapsed, when the power of the reproducing apparatus 1 is turned on, the display section 10 displays the alarm indication. Thus, even if the user repetitively turns on and off the power of the reproducing apparatus 1, since the expiration date alarm indication is not displayed, he or she does not feel bothersome.

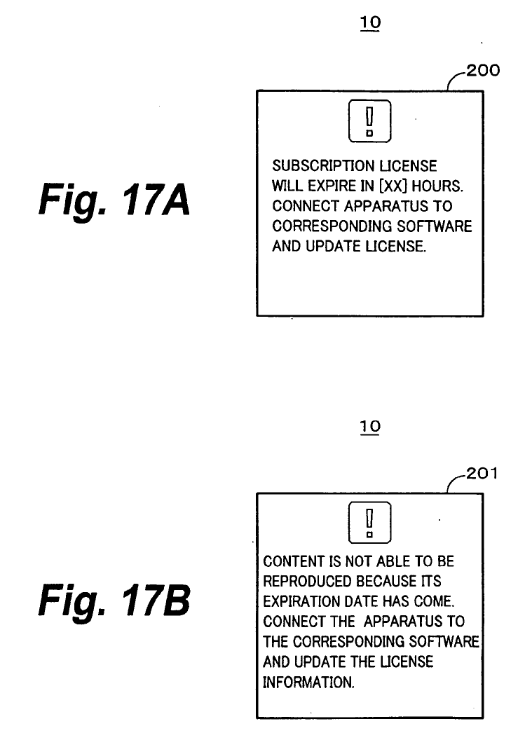

FIG. 17A shows an example of an alarm indication displayed at step S34. An alarm indication screen 200 displayed on the display section 10 indicates a message which describes that an expiration date will come soon. In the example shown in FIG. 17A, the message describes for example “The subscription license will expire in [xx] hours. Connect the apparatus to the corresponding software and update the license information.” The message not only describes the remaining time period of the license, but prompts the user to update the license.

The remaining time period of the expiration date can be obtained by calculating the difference between the trusted time and the expiration date information described in the license list file 111. The remaining time period of the expiration date is updated whenever the reproducing apparatus 1 gets started, the process of the flow chart shown in FIG. 15 is executed, and the alarm indication is displayed at step S34. When the license information described in the license list file 111 contains a plurality of licenses whose expiration dates will be soon come, the alarm indication screen 200 may be displayed corresponding to the nearest expiration date.

In the foregoing description, the process of the flow chart shown in FIG. 15 is performed whenever the reproducing apparatus 1 gets started. Instead, the process of the flow chart shown in FIG. 15 may be performed only when the reproducing apparatus 1 gets started first time every day. For example, the start times of the reproducing apparatus 1 may be recorded on a log. When the reproducing apparatus 1 gets started, with reference to the log, it is determined whether the reproducing apparatus 1 gets started first time on the day. When the determined result denotes that the reproducing apparatus 1 got started first time on the day, the foregoing process is performed. Instead, a flag that denotes whether the reproducing apparatus 1 got started first time on the day may be used.

In this case, the process of the flow chart shown in FIG. 15 may be performed one time every several days rather than every day.

As described above, when the reproducing apparatus 1 gets started, it is determined whether there is a license whose expiration date will come soon. On the other hand, when subscription content is reproduced, it is determined whether the expiration date of the license has come and the subscription content is unable to be reproduced.

Subscription content is selected from a list of content displayed on the display section 10. The selected subscription content is commanded to be reproduced. When the selected subscription content is commanded to be reproduced, as shown on the right of FIG. 16, both a license number and an expiration date of the subscription content commanded to be reproduced are checked. The license list file 111 is searched corresponding to the license number. It is determined whether the expiration date of the service to which the subscription content belongs will come soon and the expiration date of the subscription content will come soon according to the checked result. According to these determined results, it is determined whether to display an alarm indication according to for example an earlier expiration date. Instead, a priority level may be assigned to subscription content itself and a service.

FIG. 17B shows an example of an alarm indication displayed on the display section 10 when designated subscription content is not able to be reproduced because its expiration date has come. An alarm indication screen 201 displayed on the display section 10 indicates a message describing that the designated subscription content is not able to be reproduced because it expiration date has come. In the example shown in FIG. 17B, the message describes for example “Content is not able to be reproduced because its expiration date has come. Connect the apparatus to the corresponding software and update the license information”. The alarm indication screen 201 displays a message describing that the designated subscription content is not able to be reproduced because its expiration date has come and that the user is prompted to update the license.

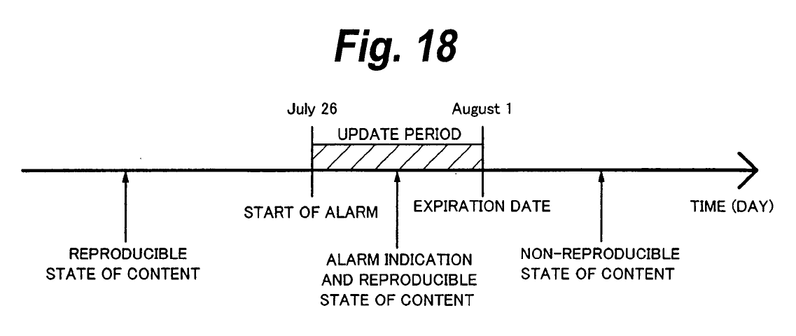

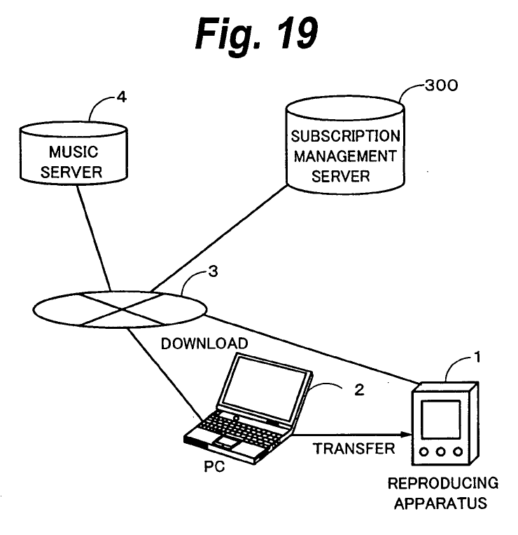

FIG. 18 shows an example of the relationship among an expiration date of a license, reproducible and non-reproducible states of subscription content on the basis of the license, and an alarm indication on a time axis. In this example, it is assumed that the reproduction expiration date of the subscription content on the basis of the license is August 1 and that the period for five days earlier than the expiration date (namely, July 26 to August 1) is the license update period. In addition, it is assumed that the alarm indication describing that an expiration date will come soon is displayed in the license update period.

Before July 26, namely before the license update period, the subscription content on the basis of the license can be reproduced. Thus, no alarm indication is displayed. After July 26, namely in the license update period, when the reproducing apparatus 1 gets started, the alarm indication screen 200 which indicates that there is a license whose expiration date will come soon is displayed on the display section 10. During the license update period, subscription content on the basis of a license whose expiration date will come soon can be reproduced.

When the license update period ceased on August 1, the expiration date of the license has come. As a result, subscription content on the basis of the license is not able to be reproduced. After the period ceased, the determined result at step S32 of the flow chart shown in FIG. 15 denotes that there is no license whose expiration date will come soon. Thus, the alarm indication screen 200 is not displayed at step S34. In contrast, when the subscription content on the basis of the license is commanded to be reproduced, the expiration date information of the subscription content and the license information are checked. As a result, it is determined that the expiration date of the license has come. According to the determined result, the subscription content is not able to be reproduced. In addition, the alarm indication screen 201 indicating that the expiration date of the license has come is displayed on the display section 10.

In the foregoing, information denoting that a license whose expiration date will come soon and information denoting that a license whose expiration date has come are displayed as the alarm indication screens 200 and 201, respectively. However, they are just examples. Instead, a simple displaying device such as an Light Emitting Diode (LED) may be additionally provided. With the displaying device, an alarm indication may be displayed. Instead, the user may be acoustically informed of these kinds of information.

In the foregoing example, it is assumed that the record medium of the reproducing apparatus 1 is the hard disk drive 32. However, it is just an example. Instead, a rewritable ROM such as a flash memory may be used as the record medium on which content data and so forth are recorded. In addition, the record medium is not limited to a built-in type of the reproducing apparatus 1. Instead, a detachable record medium may be used for the reproducing apparatus 1.

A communication section which performs wireless data communication with the reproducing apparatus 1 may be also disposed. In this case, when the communication section of the reproducing apparatus 1 is present in a wireless communication range, the display section 10 can display for example the alarm indication screens 200 and 201, which indicate that a license whose expiration date will come soon and a license whose expiration date has come, respectively. In this case, the communication section can wirelessly communicate with the music server 4 through the Internet 3 and quickly obtain license information.

In addition, as exemplified in FIG. 19, according to an embodiment of the present invention, the reproducing apparatus 1 may have content data whose subscription expiration date will come soon and content data whose subscription expiration date has come. In this embodiment, the reproducing apparatus 1 communicates with a subscription management server 300 which manages contracts of subscription content to execute updating of licenses. The subscription management server 300 is a server which manages expiration dates of content data for users who have been registered for a subscription service. The subscription management server has at least a management section which stores a database correlating users, terminals, content data, and expiration related information, a communication section which communicates with the reproducing apparatus 1, and an update section which updates a license. With reference to the database, content data whose expiration date will come soon and content data whose expiration date has come may be identified. The subscription management server may notify the reproducing apparatus 1 which stores content data that there are content data whose expiration date will come soon and content data whose expiration date has come. According to this embodiment, when the reproducing apparatus 1 is present in an area of which the reproducing apparatus 1 can communicate with the subscription management server 300 such as a wireless LAN radio wave receivable area, the reproducing apparatus 1 transmits license update request information to the subscription management server. The subscription management server executes updating of the license. The subscription management server transmits the updated license to the reproducing apparatus 1. When the reproducing apparatus 1 stores the license, the reproducing apparatus 1 can reproduce content data whose license was updated. When the user executes an operation for a license update request in an area in which the reproducing apparatus 1 is not able to receive wireless LAN radio wave, the reproducing apparatus 1 sets a flag to content for which the user has requested to update the license. When the reproducing apparatus 1 enters the wireless LAN radio wave receivable area, the reproducing apparatus 1 notifies the subscription management server of the license update request for the content to which the flag was set. After the subscription management server has updated the license, the server may send the updated license to the reproducing apparatus 1.

After the expiration date of a license of content data had come, if the license was not updated in a predetermined time period, the content data may be erased from the reproducing apparatus 1.

In the foregoing description, it is assumed that content is audio data. However, this is just an example. In other words, as long as content has time information and chronologically varies, the content may be video data.

It should be understood by those skilled in the art that various modifications, combinations, sub-combinations and alternations may occur depending on design requirements and other factors insofar as they are within the scope of the appended claims or the equivalents thereof.

1. A reproducing apparatus, comprising:
a recording section which records content data;
a reproducing section which reproduces the content data;
a time information generating section which generates time information; and
a controlling section which checks whether the recording section records content data whose expiration date will come soon based on the time information generated by the time information generating section when the reproducing apparatus gets started,
wherein when the recording section records content data whose expiration date will come soon, the controlling section notifies a user of the content data whose expiration date will come soon.

2. The reproducing apparatus as set forth in claim 1,
wherein the controlling section notifies the user of a time period until the expiration date of the content data comes when the reproducing apparatus gets started.

3. The reproducing apparatus as set forth in claim 1,
wherein the controlling section notifies the user that the content data whose expiration date will come soon based on the time information generated by the time information generating section only when the reproducing apparatus gets started a first time every day.

4. The reproducing apparatus as set forth in claim 3,
wherein the controlling section notifies the user that the content data whose expiration date will come soon every several days.

5. The reproducing apparatus as set forth in claim 1,
wherein when the reproducing apparatus gets started and the user confirms that the content data whose expiration date has come, the controlling section does not notify him or her of the content data whose expiration date has come.

6. The reproducing apparatus as set forth in claim 1,
wherein the controlling section checks whether an expiration date of content data to be reproduced has come based on the time information generated by the time information generating section, and
wherein when the expiration date of the content data has come, the controlling section selects content data from a list of content and reproduces the selected content data.

7. The reproducing apparatus as set forth in claim 1,
wherein the controlling section checks whether the recording section records content data whose expiration date will come soon based on license information which is recorded in the recording section corresponding to the content data.

8. The reproducing apparatus as set forth in claim 1,
wherein the controlling section also updates the expiration date of the content data when the expiration date will come soon.

9. The reproducing apparatus as set forth in claim 1, further comprising:
a communication section which transmits and receives data to and from an external device,
wherein when the reproducing apparatus is present in an area of which the communicating section can communicate with the external device, the controlling section updates the expiration date of the content data.

10. The reproducing apparatus as set forth in claim 1,
wherein after an expiration date of a license of content data had come, if the license was not updated for a predetermined time period, the controlling section deletes the content data from the recording section.

11. A reproducing method for reproducing content data, comprising the steps of:
generating time information;
checking whether a recording apparatus has content data whose expiration date will come soon based on the time information when the reproducing apparatus gets started; and
notifying a user of the content data whose expiration date will come soon when the reproducing apparatus has content data whose expiration date will come soon.

12. The reproducing method as set forth in claim 11,
wherein the notifying step is performed by notifying the user of a time period until the expiration date comes when the reproducing apparatus has content data whose expiration date will come soon.

13. The reproducing method as set forth in claim 11,
wherein the notifying step is performed by notifying the user that the content data whose expiration date will come soon based on the generated time information only when the reproducing apparatus gets started a first time every day.

14. The reproducing method as set forth in claim 13,
wherein the notifying step is performed by notifying the user that the content data whose expiration date will come soon every several days.

15. The reproducing method as set forth in claim 11,
wherein when the reproducing apparatus gets started and the user confirms that the content data whose expiration date has come, the notifying step is not performed.

16. The reproducing method as set forth in claim 11,
wherein the checking step is performed by checking whether an expiration date of content data to be reproduced has come based on the generated time information, and
wherein when the expiration date of the content data has come, the reproducing method further comprising the steps of:
selecting content data from a list of content; and
reproducing the selected content data.

17. The reproducing method as set forth in claim 11, wherein the checking step is performed by checking whether the reproducing apparatus has content data whose expiration date will come soon based on license information which the reproducing apparatus has corresponding to the content data.

18. The reproducing method as set forth in claim 11, further comprising the step of:
updating the expiration date of the content data when the expiration date will come soon.

19. The reproducing method as set forth in claim 11, further comprising the steps of:
transmitting and receiving data to and from an external device;
updating the expiration date of the content data when the reproducing apparatus is present in an area of which the reproducing apparatus can communicate with the external device.

20. The reproducing method as set forth in claim 11, further comprising the step of:
deleting the content data from the reproducing apparatus after an expiration date of a license of content data had come if the license was not updated for a predetermined time period.

21. A system having a reproducing apparatus and an external device,
wherein the reproducing apparatus comprises:
a recording section which records content data;
a reproducing section which reproduces the content data;
a time information generating section which generates time information; and
a controlling section which checks whether the recording section records content data whose expiration date will come soon based on the time information generated by the time information generating section when the reproducing apparatus gets started,
wherein when the recording section records content data whose expiration date will come soon, the controlling section notifies a user of the content data whose expiration date will come soon fold transmits license information of content data whose expiration date will come soon to the external device, and
wherein the external device comprises:
a communication section which communicates with the reproducing apparatus;
a managing section which manages license related information; and
an updating section which updates license information transmitted from the external device based on the license information transmitted from the reproducing apparatus and the license related information managed by the managing section.
